(19) United States
(12) Patent Application Publication
(10) Pub. No.: US 2008/0236310 A1
(43) Pub. Date: Oct. 2, 2008

(54) MOTOR MOUNT WHICH ALLOWS MOVEMENT OF THE MOTOR ONLY IN A BELT TENSIONING DIRECTION

(76) Inventor: Elgin Richard Zelinski, Winnipeg (CA)

Correspondence Address: ADE & COMPANY INC., 2157 Henderson Highway, WINNIPEG, MB, R2G1P9, CA

(21) Appl. No.: 11/691,811

(22) Filed: Mar. 27, 2007

(51) Int. Cl. F16H 7/08

(52) U.S. Cl. 74/26

(57) ABSTRACT

A motor drive apparatus comprises a motor, a pulley driven by the motors a driven element and a belt drive connecting the pulley and the driven element. The motor is mounted on a motor base and a pivot base connected by a shaft around which one pivots relative to the other. The motor is arranged on the motor base such that its weight causes the motor to pivot away from the drive element in a belt tensioning direction. A one-way clutch bearing is provided on the shaft and includes a link connected to an outer sleeve of the bearing and extending to the pivot base to allow pivotal movement tin the belt tensioning direction while preventing the motor from pivoting back toward the drive element, thereby keeping the belt drive taut.

The present invention relates to an apparatus comprising a motor mount which allows pivotal movement of the motor only in a belt tensioning direction for keeping a belt drive taut while inhibiting motor bounce by preventing pivotal movement in the opposite direction.

### BACKGROUND OF THE INVENTION

A common problem encountered with drive elements driven by a motorized pulley and belt arrangement is that, over time, the belt drive stretches. As the maintenance of the belt tension is of prime importance, anything that permits the belt to slacken produces a wide range of detrimental problems, such as for example, noise, vibration, excessive belt wear and reduction in bearing life. The end result is that, eventually, the apparatus must be shut down for maintenance. A known solution is to arrange the motor to pivot so that as the belt drive slackens due to belt stretch, the motor pivots away from the drive element, thereby tightening the belt. However in some cases, the motor is not prevented from pivoting towards the driven element. This may result in the motor assembly bouncing due to the alternating relaxing and tightening of the belt drive acting between the pulleys.

In U.S. Pat. No. 5,921,876 of the present Applicants issued Jul. 13, 1999 is disclosed an arrangement which resists movement of the motor in the belt loosening direction by providing a linear slide which moves in one direction but not the other direction. However this arrangement tends to bind and thus can jam preventing movement in either direction.

In U.S. Pat. No. 6,050,915 (Walworth) issued April 18, 2000, U.S. Pat. No. 4,865,289 (Lawson) issued Sep. 12, 1989 and U.S. Pat. No. 4,768,930 (Grime) issued Sep. 6, 1988 are shown further examples of similar devices.

### SUMMARY OF THE INVENTION

It is one object of the invention, therefore, to provide an apparatus for use with motor-driven assemblies comprising a motor base arranged to pivot in one direction for tightening a belt drive.

According to the invention, there is provided an apparatus comprising:

a motor having a drive pulley thereon;

a driven element having a driven pulley thereon;

a belt drive connecting the drive pulley and the driven pulley;

a motor base on which the motor is mounted for support thereby;

a pivot support base on which the motor base is mounted for pivotal movement relative thereto about a pivot axis in a belt tensioning direction and in an opposite belt slackening direction;

the motor, the motor base and the pivot support base being arranged so as to provide a force tending to cause pivoting of the motor base about the pivot axis in the belt tensioning direction,

a pivotal connection between the motor base and the pivot support base about which the pivotal movement takes place;

the pivotal connection being fixed to one of the motor base and the pivot support base and being rotatable relative to the other of the motor base and the pivot support base;

a one-way clutch having one part attached to said one of the motor base and the pivot support base which is rotatable relative to another part in one direction but which is prevented from rotation relative to the other part in an opposed direction;

and a link connected between the other part and said other of the motor base and the pivot support base;

the one-way clutch and the link being arranged to allow rotation of the shaft about the axis relative to said other of the motor base and the pivot support base in the belt tightening direction;

the one-way clutch and the link being arranged to prevent rotation of the shaft about the axis relative to said other of the motor base and the pivot support base in the belt slackening direction.

While in many cases a one-way clutch bearing will be used which provides pivot bearings but also there are several instances where a simpler “one-way clutch” can be used. Also note that this design does require the use pivot bearings so that it can be less expensive.

According to a second aspect of the invention there is provided an apparatus comprising:

a motor having a drive pulley thereon;

a driven element having a driven pulley thereon;

a belt drive connecting the drive pulley and the driven pulley;

a motor base on which the motor is mounted for support thereby;

a pivot support base on which the motor base is mounted for pivotal movement relative thereto about a pivot axis in a belt tensioning direction and in an opposite belt slackening direction;

the motor, the motor base and the pivot support base being arranged so as to provide a force tending to cause pivoting of the motor base about the pivot axis in the belt tensioning direction:

a shaft connected between the motor base and the pivot support base about which the pivotal movement takes place;

the shaft being fixed to one of the motor base and the pivot support base and being rotatable relative to the other of the motor base and the pivot support base;

a one-way clutch bearing mounted on the shaft and having an inner part rotatable with the shaft, an outer part surrounding the inner part which is rotatable relative to the inner part in one direction but which is prevented from rotation relative to the inner part in an opposed direction;

and a link connected between the outer part and said other of the motor base and the pivot support base;

the one-way clutch bearing and the link being arranged to allow rotation of the shaft about the axis relative to said other of the motor base and the pivot support base in the belt tightening direction;

the one-way clutch bearing and the link being arranged to prevent rotation of the shaft about the axis relative to said other of the motor base and the pivot support base in the belt slackening direction.

The apparatus may use a one-way clutch bearing; but it is possible that this arrangement may use some other “one-way clutch” design such as for example a Sprague clutch.

The predetermined tensioning may be provided by a spring or springs but this is an optional arrangement and the weight of the motor or other biasing force may be used.

Preferably the shaft is fixed to the motor base and rotates relative to the pivot support base and wherein the link is connected to the pivot support base.

Preferably the shaft is carried in a pair of spaced bearings mounted on the pivot support base.

Preferably the motor base comprises a channel member with a pair of side flanges connected to the shaft and a transverse mounting plate between the flanges on which the motor is mounted.

Preferably the force tending to cause pivoting of the motor base about the pivot axis in the belt tensioning direction is provided by the weight of the motor.

Preferably the link is connected to the outer part by a connector which can be readily released to allow rotation of the outer part relative to the link for adjustment movement and reconnected after the adjustment movement.

Preferably the link is connected to the outer part by a clamping collar surrounding the outer part which can be readily released from clamping action to allow rotation of the outer part relative to the link for adjustment movement and re-clamped after the adjustment movement.

Preferably there is provided a single one-way clutch and link on one end of the shaft since this provides generally the amount of force required. However where required for additional force control, there may be provided a first one-way clutch and link on one end of the shaft and a second one-way clutch and link on an opposed end of the shaft. Yet further devices can be provided in extreme cases.

Thus, as the belt drive slackens, the motor will pivot away from the driven element, thereby tightening the belt drive. Furthermore, the one-way restraint provided by the one-way clutch bearings on the shaft prevents the motor from pivoting towards the driven element, thereby preventing bouncing of the motor assembly. As the movement is effected by the rotation of the one-way clutch bearing there can be no binding action which can occur with linear movement of the type shown in the above previous patent of the present Applicants.

The arrangement described herein is also adaptable for installation on to pre-existing pivoting-motor-mounts in which case the components to be supplied to attach to the existing components will include the one-way clutch bearing together with a stub shaft component which mounts on the shaft.

The one-way clutch bearing includes as outer sleeve; an inner sleeve; an outer ring with provision for clamping on to outer bearing sleeve; a link arm for fixing outer bearing sleeve to non-rotating portion of motor mount.

The stub-shaft component includes provision for fixing to the inner sleeve of the one-way bearing and a provision for fixing to the rotating portion of motor mount.

It will be appreciated that the shaft can be fixed relative to the motor base in which case the link extends from the outer part on the shaft to the pivot support base or the shaft can be fixed relative to the pivot support base in which case the link extends from the outer part on the shaft to the motor base.

### BRIEF DESCRIPTION OF THE DRAWINGS

One embodiment of the invention will now be described in conjunction with the accompanying drawings in which:

FIG. 1 is a side elevational view of the apparatus.

FIG. 2 is a front elevational view of the apparatus.

FIG. 3 is a side elevational view on an enlarged scale showing the one-way clutch bearing and the link mounted on the shaft.

FIG. 4A is a side elevational view showing the same basic arrangement mounted on a stub shaft portion for a retrofit arrangement.

FIG. 4B is an end elevational view of the stub shaft portion of FIG. 4A.

FIG. 5 is an end elevation of an alternative arrangement using two stub shafts to support the motor base on the pivot support base

In the drawings like characters of reference indicate corresponding parts in the different figures,

### DETAILED DESCRIPTION

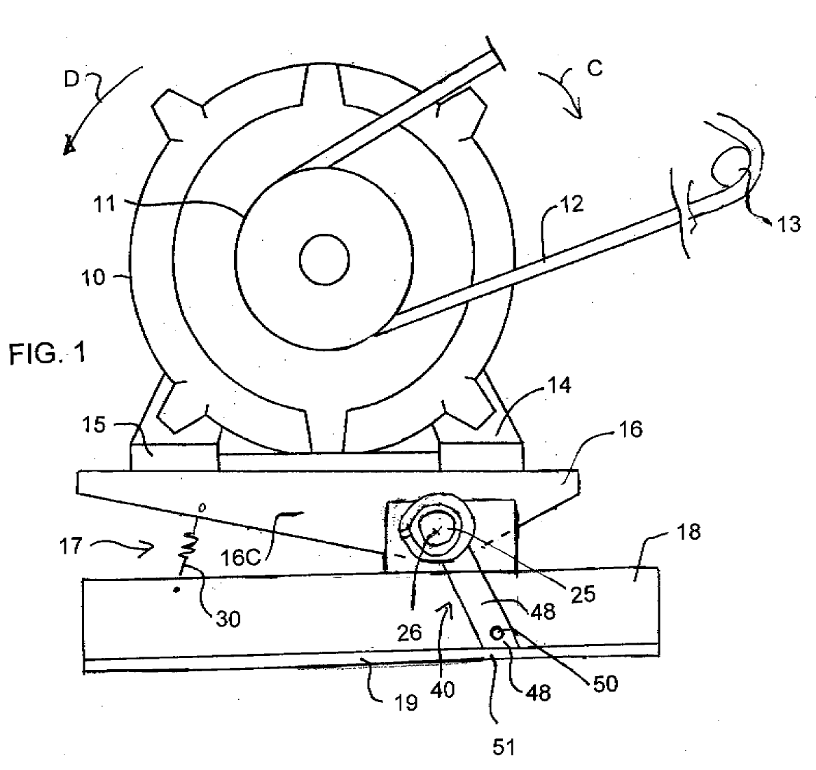

In FIG. 1 is shown a motor 10 having a drive pulley 11 thereon with the drive pulley driving a belt 12 for providing drive power to a driven element schematically indicated at 13. The motor includes a pair of lugs 14 and 15 by which the motor is mounted on a motor base 16 for support of the motor at a required location for driving the driven element 13. The motor base 16 forms part of a pivot mounting generally indicated at 17 which includes a pivot support base 18 having a base flange 19 for attachment to a suitable support.

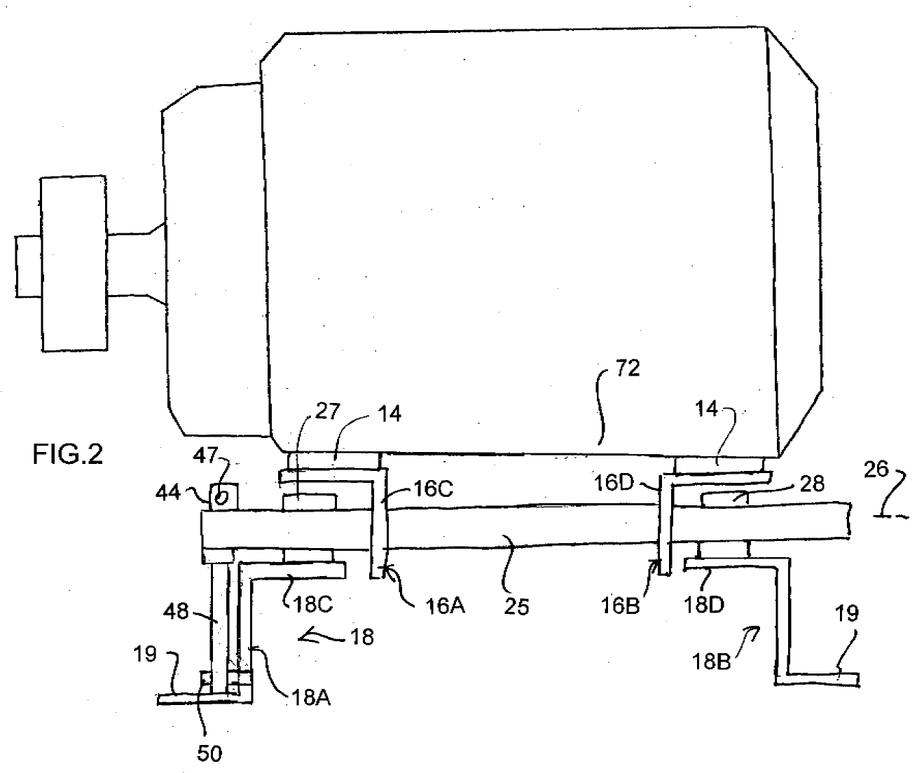

As best shown in FIG. 2, the motor base is formed by a pair of angle members 16A and 16B which are fastened to the lugs 14 and 15. The angle members provide a horizontal flange attached to the motor lugs and the depending vertical flange 16C and 16D.

The pivot support base 18 is similarly formed by a pair of angle members 18A and 18B. Each of these members includes the flange 19 which is attached to a suitable support together with a vertical flange portion and a horizontal flange portion 18C, 18D. Pivotal movement of the motor relative to the base 18 is allowed by a pivot shaft 25 which is fixed to the flanges 16C and 16D underneath the motor. Thus the shaft 25 pivots around a shaft axis with the motor with the pivotal movement occurring relative to the base 19. In order to allow this pivotal movement, the shaft is attached to the flanges 18C and 18D by a pair of bearings 27 and 28 suitably mounted on the flanges.

A suitable spring force is applied between the motor base and the pivot support base and a schematic indicated at a spring 30. It will be appreciated that the spring can be located at suitable location relative to the base members either at the shaft or a position spaced from the shaft. The number and arrangement of the springs can be varied to provide the necessary force pulling between the base members and tending to pivot the motor about the axis 26 of the shaft 25 in a counter-clockwise direction as shown in FIG. 1.

In replacement for the use of a spring to provide the biasing action in the required direction, the biasing force can be provided by the weight of the motor itself with the pivot axis located at a required position to provide that force.

Thus stretching of the belt 12 is accommodated by the pivotal movement of the motor in the direction D which moves the motor away from the driven element 13 to again tension the belt 12. The spring force provides a predetermined tensioning which can be arranged so that it is suitable for the dimensions and type of the belt concerned.

In order to prevent pivotal movement of the motor in the clockwise direction C which would tend to loosen the belt, there is provided a rotation preventing device generally indicated at 40. This device is provided so that the movement of the motor in the direction D to accommodate the belt stretch is not returned during the application of forces to the motor tending to turn it in the direction C. Thus each increment of movement of the motor in the belt tensioning direction is prevented from returning. As is known, this anti-reverse system prevents motor bounce at various times during operation of the system.

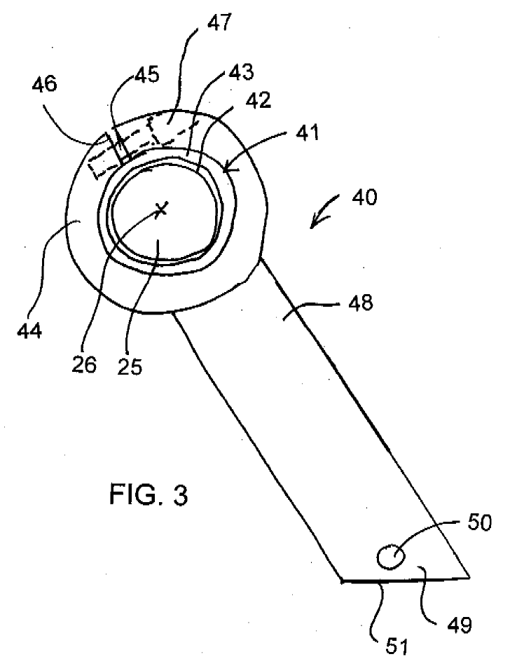

As shown in FIG. 3, the anti-reverse device 40 comprises a one-way bearing 41 mounted on the shaft 25. The one-way bearing includes an inner part 42 carried on the shaft and an outer part 43 which rotates relative to the inner part. The inner part can be provided by an inner race which is carried on the shaft with the bearing members between the inner race and an outer race forming the outer part 43. Alternatively the inner race may be omitted and the bearing elements mounted directly on the outer surface of the shaft.

The bearing is arranged with bearing elements which allow rotation of the outer part in one direction but prevent rotation in the reverse direction. Bearings of this type are previously known and are commercially available from a number of different manufacturers.

Around the outer part 43 is mounted a clamping ring 44 which is clamped in place by a screw 45 pulling together the clamping ring at a break 46 between two parts of the clamping ring. The screw can be tightened by inserting an Allen key or the like into an opening 47 in one side of the clamping ring.

The clamping ring is attached to a link 48 which extends outwardly from the clamping ring in a radial plane of the axis 26 to an outer end 49 of the link which is a spaced outwardly from the shaft 25. The outer end 49 of the link 48 is suitably attached to the pivot support bracket. In the example shown, the link 48 is attached by a pin 50 to the vertical flange of the pivot support base at a position adjacent the bottom flange 19. An end face 51 of the link abuts against the flange 19 as best shown in FIG. 1 so as to communicate forces from the rotation to the flange rather than through the pin 50. However different mounting arrangements can be used for the end of the link to the pivot support base.

The one-way bearing is arranged so that it allows rotation of the shaft 25 and the inner part in the counter-clockwise direction while the outer pan of the bearing is held fixed by the link 48 and the pin 50. In the event that the motor receives forces tending to move the motor in the clockwise direction C, the one-way bearing prevents the rotation of the shaft and the inner part of the bearing in the counter-clockwise direction since it is fixed against rotation relative to the outer part. The outer part is held against rotation by the link. It will be noted that the link is inclined downwardly and toward the right so that it acts as a wedge against the flange 19 when the forces are applied from the motor tending to rotate the shaft, the outer part, the clamping ring and the link in the clockwise direction.

In the event that the mass of the structure is sufficient that the forces can exceed those which can be reasonably accommodated by the clamp ring and the link, a second symmetrical arrangement can be applied on the opposite end of the shaft.

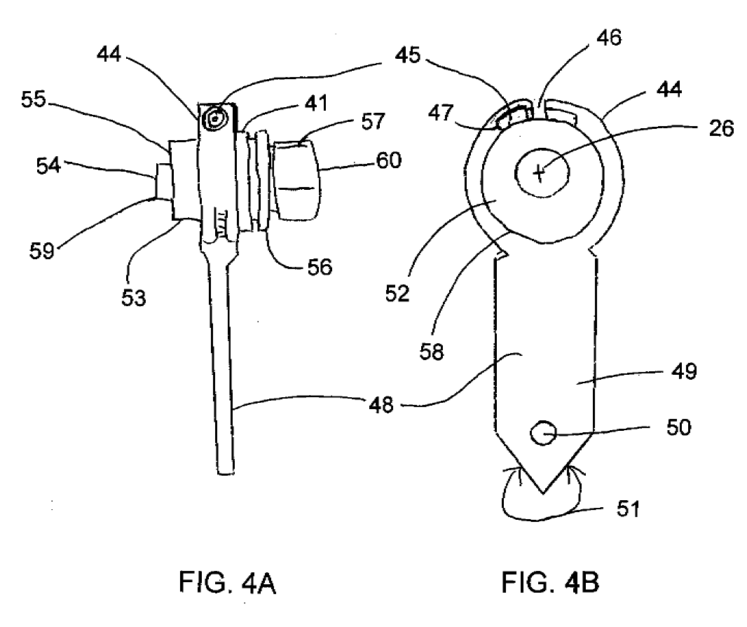

Turning now to FIG. 4, an alternative arrangement is shown which utilizes the same one-way bearing, clamping ring and link but in this situation the inner part of the bearing is attached to a stub shaft 60 which is attached onto the end of the shaft 25. This arrangement allows the components by the one-way bearing, clamping ring and link to be supplied with the stub shaft in a manner which allows these elements to be attached as a retrofit to an existing motor and pivot mount assembly.

The stub shaft (auxiliary shaft) assembly 60 consists of the stub portion 52, complete with a fixing mechanism 59 which includes a collar which can be attached to a shaft such as to shaft 25. The collar includes a fixing surface 54 and also and a collar retaining mechanism 55. The stub shaft is fitted with a collar 53 complete with stub fixing mechanism 55 which acts as an inner race for the one-way clutch bearing 41. The collar is fixed onto the stub shaft with a washer 56 and a nut 57 which mates with the collar retaining mechanism. In the arrangement shown the fixing mechanism is mechanically attached to the motor pivot base shaft 25. The outer surface of the collar 53 now acts in the manner of the outer surface of shaft 25 as previously described.

The fixing mechanism 59 is shown as a key which is weldable to the shaft 25 but the invention is not limited to a weldable key and other mounting arrangements may be used to attach the stub shaft assembly to shaft 25.

The collar to shaft fixing surface is shown as a face of a key but as above the invention is not limited to a key. The collar retaining mechanism is not absolutely necessary as the stub shaft assembly may be held in place by the pin 50. The collar retaining mechanism is included to give the user the option on not having to use the pin 50, which in some retrofit situations may not be practical. Also, the collar retaining mechanism is represented with a threaded arrangement but other arrangements may be used. For example, another configuration could be a washer and “cotter-pin” which would work equally well.

A collar is not absolutely necessary since the bearing may mounted directly onto the outer surface of the stub shaft. However but the separate collar allows for the facilitation of mounting the stub shaft to the pivot base shaft 25. The washer and nut may not be necessary. Also the washer and nut may be combined into an integral nut-washer combination.

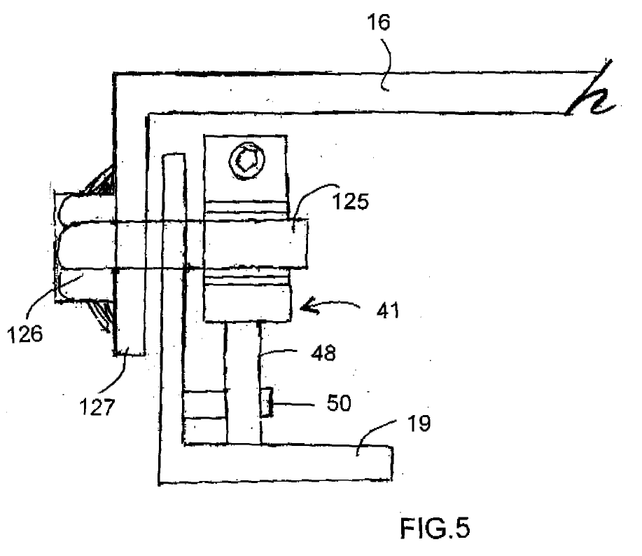

The arrangement described above includes a shaft connecting the “pivot support base (19)” and the “motor base (16)”. It is not required that this be a solid single shaft. Thus it is possible to have an arrangement where the motor base pivots on separate pivot shafts or separate pivot elements arranged coaxial at the pivot axis. FIG. 5 provides such an arrangement where the motor base 16 is carried on a pair of stub shafts 125 at respective sides and is attached to the shaft by a welded nut 126 on a down-turned flange 127. The one-way bearing or clutch is carried on the stub shaft on the inside of the down-turned flange 127 and inside an up-turned flange 128 of the pivot support base 19 so that it is contained within the base and away from damage although it may be accessed from the ends of the mounting base.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. Apparatus comprising:
a motor having a drive pulley thereon;
a driven element having a driven pulley thereon;
a belt drive connecting the drive pulley and the driven pulley;
a motor base on which the motor is mounted for support thereby;
a pivot support base on which the motor base is mounted for pivotal movement relative thereto about a pivot axis in a belt tensioning direction and in an opposite belt slackening direction;
the motor, the motor base and the pivot support base being arranged so as to provide a force tending to cause pivoting of the motor base about the pivot axis in the belt tensioning direction;
a shaft connected between the motor base and the pivot support base about which the pivotal movement takes place;
the shaft being fixed to one of the motor base and the pivot support base and being rotatable relative to the other of the motor base and the pivot support base;
a one-way clutch bearing mounted on the shaft and having an inner part rotatable with the shaft, an outer part surrounding the inner part which is rotatable relative to the inner part in one direction but which is prevented from rotation relative to the inner part in an opposed direction;
and a link connected between the outer part and said other of the motor base and the pivot support base;
the one-way clutch bearing and the link being arranged to allow rotation of the shaft about the axis relative to said other of the motor base and the pivot support base in the belt tightening direction;
the one-way clutch bearing and the link being arranged to prevent rotation of the shaft about the axis relative to said other of the motor base and the pivot support base in the belt slackening direction.

2. The apparatus according to claim 1 wherein the shaft is fixed to the motor base and rotates relative to the pivot support base and wherein the link is connected to the pivot support base.

3. The apparatus according to claim 1 wherein the shaft is carried in a pair of spaced bearings mounted on the pivot support base.

4. The apparatus according to claim 1 wherein the motor base comprises a channel member with a pair of side flanges connected to the shaft and a transverse mounting plate between the flanges on which the motor is mounted.

5. The apparatus according to claim 1 wherein the force tending to cause pivoting of the motor base about the pivot axis in the belt tensioning direction is provided by the weight of the motor.

6. The apparatus according to claim 1 wherein the link is connected to the outer part by a connector which can be readily released to allow rotation of the outer part relative to the link for adjustment movement and reconnected after the adjustment movement.

7. The apparatus according to claim 1 wherein the link is connected to the outer part by a clamping collar surrounding the outer part which can be readily released from clamping action to allow rotation of the outer part relative to the link for adjustment movement and re-clamped after the adjustment movement.

8. The apparatus according to claim 1 wherein there is provided a single one-way clutch and link on one end of the shaft.

9. The apparatus according to claim 1 wherein there is provided a first one-way clutch and link on one end of the shaft and a second one-way clutch and link on an opposed end of the shaft apparatus comprising:

10. Apparatus comprising:
a motor having a drive pulley thereon;
a driven element having a driven pulley thereon;
a belt drive connecting the drive pulley and the driven pulley;
a motor base on which the motor is mounted for support thereby;
a pivot support base on which the motor base is mounted for pivotal movement relative thereto about a pivot axis in a belt tensioning direction and in an opposite belt slackening direction;
the motor, the motor base and the pivot support base being arranged so as to provide a force tending to cause pivoting of the motor base about the pivot axis in the belt tensioning direction;
a pivotal connection between the motor base and the pivot support base about which the pivotal movement takes place;
the pivotal connection being fixed to one of the motor base and the pivot support base and being rotatable relative to the other of the motor base and the pivot support base;
a one-way clutch having one part attached to said one of the motor base and the pivot support base which is rotatable relative to another part in one direction but which is prevented from rotation relative to the other part in an opposed direction;
and a link connected between the other part and said other of the motor base and the pivot support base;
the one-way clutch and the link being arranged to allow rotation of the shaft about the axis relative to said other of the motor base and the pivot support base in the belt tightening direction;
the one-way clutch and the link being arranged to prevent rotation of the shaft about the axis relative to said other of the motor base and the pivot support base in the belt slackening direction.

11. The apparatus according to claim 10 wherein the motor base comprises a channel member with a pair of side flanges connected to the pivot connection and a transverse mounting plate between the flanges on which the motor is mounted.

12. The apparatus according to claim 10 wherein the force tending to cause pivoting of the motor base about the pivot axis in the belt tensioning direction is provided by the weight of the motor.

13. The apparatus according to claim 10 wherein the link is connected to the one-way clutch by a connector which can be readily released to allow rotation of the outer part relative to the link for adjustment movement and reconnected after the adjustment movement.

14. The apparatus according to claim 10 wherein the link is connected to the one-way clutch by a clamping collar which can be readily released from clamping action to allow rotation relative to the link for adjustment movement and re-clamped after the adjustment movement.

15. The apparatus according to claim 10 wherein there is provided a single one-way clutch and link on one end of the pivot connection.

16. The apparatus according to claim 10 wherein the pivot connection comprises two stub shafts and there is provided a first one-way clutch and link on one stub shaft and a second one-way clutch and link on the other stub shaft.
